(19) United States
(12) Patent Application Publication
(10) Pub. No.: US 2026/0222872 A1
(43) Pub. Date: Jul. 30, 2026

(54) ASYMMETRIC CONFIDENCE LEVEL FOR PREDICTIVE BEAM MANAGEMENT

(71) Applicant: QUALCOMM Incorporated, San Diego, CA (US)

(72) Inventors: Qiaoyu LI, Beijing (CN); Peter GAAL, San Diego, CA (US); Tao LUO, San Diego, CA (US); Mahmoud TAHERZADEH BOROUJENI, San Diego, CA (US)

(21) Appl. No.: 19/146,820

(22) PCT Filed: Feb. 16, 2023
(86) PCT No.: PCT/CN2023/076370

§ 371 Date: Jul. 9, 2025

(51) Int. Cl. H04W 24/10

(52) U.S. Cl. CPC H04W 24/10

(57) ABSTRACT

Methods, systems, and devices for wireless communications are described. A user equipment (UE) may report asymmetric confidence levels (e.g., a first confidence level for an upper bound of a channel quality prediction, and a second confidence level for a lower bound of the channel quality prediction). The UE may be configured with the upper bound and the lower bound (e.g., or just the lower bound) and may report asymmetric confidence levels for each predicted channel characteristic value in a channel state information (CSI) report. For example, the UE may indicate a confidence value for an upper bound and a second confidence value for a lower bound.

### CROSS REFERENCE

The present Application for Patent is a 371 national phase filing of International Patent Application No. PCT/CN2023/076370 by LI et al., entitled “ASYMMETRIC CONFIDENCE LEVEL FOR PREDICTIVE BEAM MANAGEMENT,” filed Feb. 16, 2023, assigned to the assignee hereof, and expressly incorporated by reference herein.

### FIELD OF TECHNOLOGY

The present disclosure relates to wireless communications, including asymmetric confidence level for predictive beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support asymmetric confidence level for predictive beam management. For example, a user equipment (UE) may report asymmetric confidence levels (e.g., a first confidence level for an upper bound of a channel characteristic prediction, and a second confidence level for a lower bound of the channel characteristic prediction). The UE may be configured with the upper bound and the lower bound (e.g., or just the lower bound) and may report asymmetric confidence levels for each predicted channel characteristic value in a channel state information (CSI) report. For example, the UE may indicate a confidence value for an upper bound (e.g., a first confidence level that an actual channel characteristic is no more than a threshold amount higher than a predicted channel characteristic) and a second confidence value for a lower bound (e.g., a second confidence level that the actual channel characteristic is no more than a different threshold lower than the predicted channel characteristic).

A method for wireless communications at a user equipment (UE) is described. The method may include receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction, generating, according to the asymmetric confidence value reporting scheme, a first predicted channel characteristic value for the resource, and at least one of an upper bound confidence value for the first predicted channel characteristic value or a lower bound confidence value for the first predicted channel characteristic value, and transmitting a channel state information report indicating the first predicted channel characteristic value and at least one of the upper bound confidence value or the lower bound confidence value for the first predicted channel characteristic value.

An apparatus for wireless communications at a UE is described. The apparatus may include a processor, memory coupled with the processor, and instructions stored in the memory. The instructions may be executable by the processor to cause the apparatus to receive control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction, generate, according to the asymmetric confidence value reporting scheme, a first predicted channel characteristic value for the resource, and at least one of an upper bound confidence value for the first predicted channel characteristic value or a lower bound confidence value for the first predicted channel characteristic value, and transmit a channel state information report indicating the first predicted channel characteristic value and at least one of the upper bound confidence value or the lower bound confidence value for the first predicted channel characteristic value.

Another apparatus for wireless communications at a UE is described. The apparatus may include means for receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction, means for generating, according to the asymmetric confidence value reporting scheme, a first predicted channel characteristic value for the resource, and at least one of an upper bound confidence value for the first predicted channel characteristic value or a lower bound confidence value for the first predicted channel characteristic value, and means for transmitting a channel state information report indicating the first predicted channel characteristic value and at least one of the upper bound confidence value or the lower bound confidence value for the first predicted channel characteristic value.

A non-transitory computer-readable medium storing code for wireless communications at a UE is described. The code may include instructions executable by a processor to receive control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction, generate, according to the asymmetric confidence value reporting scheme, a first predicted channel characteristic value for the resource, and at least one of an upper bound confidence value for the first predicted channel characteristic value or a lower bound confidence value for the first predicted channel characteristic value, and transmit a channel state information report indicating the first predicted channel characteristic value and at least one of the upper bound confidence value or the lower bound confidence value for the first predicted channel characteristic value.

In some examples of the method, apparatuses, and non-transitory computer-readable medium described herein, transmitting the channel state information report may include operations, features, means, or instructions for transmitting the channel state information report that indicates both the upper bound confidence value and the lower bound confidence value, where the lower bound confidence value may be different than the upper bound confidence value.

Some examples of the method, apparatuses, and non-transitory computer-readable medium described herein may further include operations, features, means, or instructions for receiving, via the control signaling, an instruction to report a single confidence value associated with the lower bound, where the channel state information report indicates the first predicted channel characteristic value and the lower bound confidence value.

Some examples of the method, apparatuses, and non-transitory computer-readable medium described herein may further include operations, features, means, or instructions for receiving, via the control signaling, an indication of at least one of a first quantization level associated with the upper bound or a second quantization level associated with the lower bound, where the channel state information report indicates at least one of the upper bound confidence value based on the first quantization level or the lower bound confidence value based on the second quantization level.

Some examples of the method, apparatuses, and non-transitory computer-readable medium described herein may further include operations, features, means, or instructions for transmitting capability information indicating at least one of the first quantization level or the second quantization level, where receiving the indication of at least one of the first quantization level or the second quantization level may be based on the capability information.

In some examples of the method, apparatuses, and non-transitory computer-readable medium described herein, the first quantization level corresponds to a first quantity of bits and the second quantization level corresponds to a second quantity of bits.

In some examples of the method, apparatuses, and non-transitory computer-readable medium described herein, transmitting the channel state information report may include operations, features, means, or instructions for transmitting a first channel state information report message including a set of multiple predicted channel characteristic values including the first predicted channel characteristic value and a confidence value feedback request and transmitting a second channel state information report message including a set of multiple asymmetric confidence values corresponding to the set of multiple predicted channel characteristic values based on the confidence value feedback request, the set of multiple asymmetric confidence values including the upper bound confidence value, the lower bound confidence value, or both.

Some examples of the method, apparatuses, and non-transitory computer-readable medium described herein may further include operations, features, means, or instructions for receiving control signaling including an indication of a threshold confidence level, where transmitting the first channel state information report message including the confidence value feedback request may be based on at least one of the upper bound confidence value or the lower bound confidence value satisfying the threshold confidence level.

In some examples of the method, apparatuses, and non-transitory computer-readable medium described herein, and the method, apparatuses, and non-transitory computer-readable medium may include further operations, features, means, or instructions for transmitting, via the channel state information report, a set of multiple predicted channel characteristic values corresponding to a set of multiple resources including the resource, and a set of confidence values, at least one confidence value of the set of confidence values corresponding to at least one predicted channel characteristic value of the set of multiple predicted channel characteristic values, where the set of multiple predicted channel characteristic values includes the first predicted channel characteristic value, and the set of confidence values includes the upper bound confidence value and the lower bound confidence value.

In some examples of the method, apparatuses, and non-transitory computer-readable medium described herein, a channel characteristic include a reference signal receive power, a signal to interference and noise ratio, a rank indicator, a channel quality information, or any combination thereof.

In some examples of the method, apparatuses, and non-transitory computer-readable medium described herein, the predicted channel characteristic value, the upper bound confidence level, the lower bound confidence level, or any combination thereof, may be based on the resources in a frequency domain, a time domain, a spatial domain, or any combination thereof.

A method for wireless communications at a network entity is described. The method may include transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction, transmitting one or more reference signals via the resource, and receiving a channel state information report indicating a first predicted channel characteristic value and at least one of an upper bound confidence value or a lower bound confidence value for the first predicted channel characteristic value.

An apparatus for wireless communications at a network entity is described. The apparatus may include a processor, memory coupled with the processor, and instructions stored in the memory. The instructions may be executable by the processor to cause the apparatus to transmit control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction, transmit one or more reference signals via the resource, and receive a channel state information report indicating a first predicted channel characteristic value and at least one of an upper bound confidence value or a lower bound confidence value for the first predicted channel characteristic value.

Another apparatus for wireless communications at a network entity is described. The apparatus may include means for transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction, means for transmitting one or more reference signals via the resource, and means for receiving a channel state information report indicating a first predicted channel characteristic value and at least one of an upper bound confidence value or a lower bound confidence value for the first predicted channel characteristic value.

A non-transitory computer-readable medium storing code for wireless communications at a network entity is described. The code may include instructions executable by a processor to transmit control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction, transmit one or more reference signals via the resource, and receive a channel state information report indicating a first predicted channel characteristic value and at least one of an upper bound confidence value or a lower bound confidence value for the first predicted channel characteristic value.

In some examples of the method, apparatuses, and non-transitory computer-readable medium described herein, receiving the channel state information report may include operations, features, means, or instructions for receiving the channel state information report that indicates both the upper bound confidence value and the lower bound confidence value, where the lower bound confidence value may be different than the upper bound confidence value.

Some examples of the method, apparatuses, and non-transitory computer-readable medium described herein may further include operations, features, means, or instructions for transmitting, via the control signaling, an instruction to report a single confidence value associated with the lower bound, where the channel state information report indicates the first predicted channel characteristic value and the lower bound confidence value.

Some examples of the method, apparatuses, and non-transitory computer-readable medium described herein may further include operations, features, means, or instructions for transmitting, via the control signaling, an indication of at least one of a first quantization level associated with the upper bound or a second quantization level associated with the lower bound, where the channel state information report indicates at least one of the upper bound confidence value based on the first quantization level or the lower bound confidence value based on the first quantization level and the second quantization level.

Some examples of the method, apparatuses, and non-transitory computer-readable medium described herein may further include operations, features, means, or instructions for receiving capability information indicating at least one of the first quantization level or the second quantization level, where transmitting the indication of at least one of the first quantization level or the second quantization level may be based on the capability information.

In some examples of the method, apparatuses, and non-transitory computer-readable medium described herein, the first quantization level corresponds to a first quantity of bits and the second quantization level corresponds to a second quantity of bits.

In some examples of the method, apparatuses, and non-transitory computer-readable medium described herein, receiving the channel state information report may include operations, features, means, or instructions for receiving a first channel state information report message including a set of multiple predicted channel characteristic values including the first predicted channel characteristic value and a confidence value feedback request and receiving a second channel state information report message including a set of multiple asymmetric confidence values corresponding to the set of multiple predicted channel characteristic values based on the confidence value feedback request, the set of multiple asymmetric confidence values including the upper bound confidence value, the lower bound confidence value, or both.

Some examples of the method, apparatuses, and non-transitory computer-readable medium described herein may further include operations, features, means, or instructions for transmitting control signaling including an indication of a threshold confidence level, where receiving the first channel state information report message including the confidence value feedback request may be based on at least one of the upper bound confidence value or the lower bound confidence value satisfying the threshold confidence level.

Some examples of the method, apparatuses, and non-transitory computer-readable medium described herein may further include operations, features, means, or instructions for receiving, via the channel state information report, a set of multiple predicted channel characteristic values corresponding to a set of multiple resources, and a set of confidence values, at least one confidence value of the set of confidence values corresponding to each predicted channel characteristic value of the set of multiple predicted channel characteristic values, where the set of multiple predicted channel characteristic values includes the first predicted channel characteristic value, and the set of confidence values includes the upper bound confidence value and the lower bound confidence value.

In some examples of the method, apparatuses, and non-transitory computer-readable medium described herein, a channel characteristic include a reference signal receive power, a signal to interference and noise ratio, a rank indicator, a channel quality information, or any combination thereof.

In some examples of the method, apparatuses, and non-transitory computer-readable medium described herein, the predicted channel characteristic value, the upper bound confidence level, the lower bound confidence level, or any combination thereof, may be based on the resources in a frequency domain, a time domain, a spatial domain, or any combination thereof.

### BRIEF DESCRIPTION OF THE DRAWINGS

FIG. 1 illustrates an example of a wireless communications system that supports asymmetric confidence level for predictive beam management in accordance with one or more aspects of the present disclosure.

FIG. 2 illustrates an example of a wireless communications system that supports asymmetric confidence level for predictive beam management in accordance with one or more aspects of the present disclosure.

FIG. 3 illustrates an example of a channel measurement scheme that supports asymmetric confidence level for predictive beam management in accordance with one or more aspects of the present disclosure.

FIG. 4 illustrates an example of a confidence level reporting scheme that supports asymmetric confidence level for predictive beam management in accordance with one or more aspects of the present disclosure.

FIG. 5 illustrates an example of a confidence level reporting scheme that supports asymmetric confidence level for predictive beam management in accordance with one or more aspects of the present disclosure.

FIG. 6 illustrates an example of a process flow that supports asymmetric confidence level for predictive beam management in accordance with one or more aspects of the present disclosure.

FIGS. 7 and 8 illustrate block diagrams of devices that support asymmetric confidence level for predictive beam management in accordance with one or more aspects of the present disclosure.

FIG. 9 illustrates a block diagram of a communications manager that supports asymmetric confidence level for predictive beam management in accordance with one or more aspects of the present disclosure.

FIG. 10 illustrates a diagram of a system including a device that supports asymmetric confidence level for predictive beam management in accordance with one or more aspects of the present disclosure.

FIGS. 11 and 12 illustrate block diagrams of devices that support asymmetric confidence level for predictive beam management in accordance with one or more aspects of the present disclosure.

FIG. 13 illustrates a block diagram of a communications manager that supports asymmetric confidence level for predictive beam management in accordance with one or more aspects of the present disclosure.

FIG. 14 illustrates a diagram of a system including a device that supports asymmetric confidence level for predictive beam management in accordance with one or more aspects of the present disclosure.

FIGS. 15 through 18 illustrate flowcharts showing methods that support asymmetric confidence level for predictive beam management in accordance with one or more aspects of the present disclosure.

### DETAILED DESCRIPTION

In some examples, a user equipment (UE) may perform channel state information (CSI) measurements and generate predicted CSI values. The UE may also report confidence values for predicted channel characteristics (e.g., symmetric confidence values, such as a predicted RSRP of −90 dB plus or minus 3 dB with a 75 percent confidence value). If the actual channel characteristic value is higher than the predicted channel characteristics value, then communications may be as or more successful than predicted based on the predicted channel characteristics value. However, if an actual channel characteristic is less than the predicted channel characteristic value (e.g., is less than a lower bound of the channel characteristic), then end-to-end performance degradation may occur.

Techniques described herein support asymmetric confidence level reporting. For example, the UE may report asymmetric confidence levels (e.g., a first confidence level for an upper bound of a channel characteristic prediction, and a second confidence level for a lower bound of the channel characteristic prediction). The UE may be configured with the upper bound and the lower bound (e.g., or just the lower bound) and may report asymmetric confidence levels for each predicted channel characteristic value in a CSI report. For example, the UE may indicate a confidence value for an upper bound (e.g., a 75 percent confidence level that an actual channel characteristic is no more than a threshold higher than a predicted channel characteristic) and a second confidence value for a lower bound (e.g., a 95 percent confidence level that the actual channel characteristic is no more than a different threshold lower than the predicted channel characteristic).

Aspects of the disclosure are initially described in the context of wireless communications systems. Aspects of the disclosure are further illustrated by and described with reference to wireless communications, channel measurement schemes, confidence level reporting schemes, and process flows. Aspects of the disclosure are further illustrated by and described with reference to apparatus diagrams, system diagrams, and flowcharts that relate to asymmetric confidence level for predictive beam management.

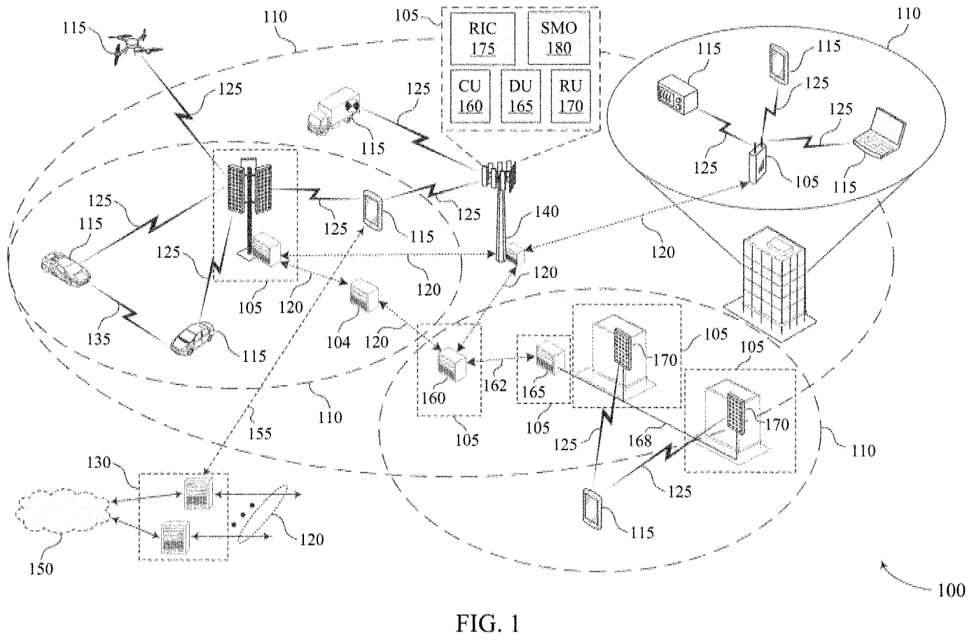

FIG. 1 illustrates an example of a wireless communications system 100 that supports asymmetric confidence level for predictive beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support asymmetric confidence level for predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may report asymmetric confidence levels (e.g., a first confidence level for an upper bound of a channel characteristic prediction, and a second confidence level for a lower bound of the channel characteristic prediction). The UE 115 may be configured with the upper bound and the lower bound (e.g., or just the lower bound) and may report asymmetric confidence levels for each predicted channel characteristic value in a CSI report. For example, the UE 115 may indicate a confidence value for an upper bound (e.g., a 75% confidence level that an actual channel characteristic is no more than a threshold more than a predicted channel characteristic) and a second confidence value for a lower bound (e.g., a 95% confidence level that the actual channel characteristic is no more than a different threshold lower than the predicted channel characteristic).

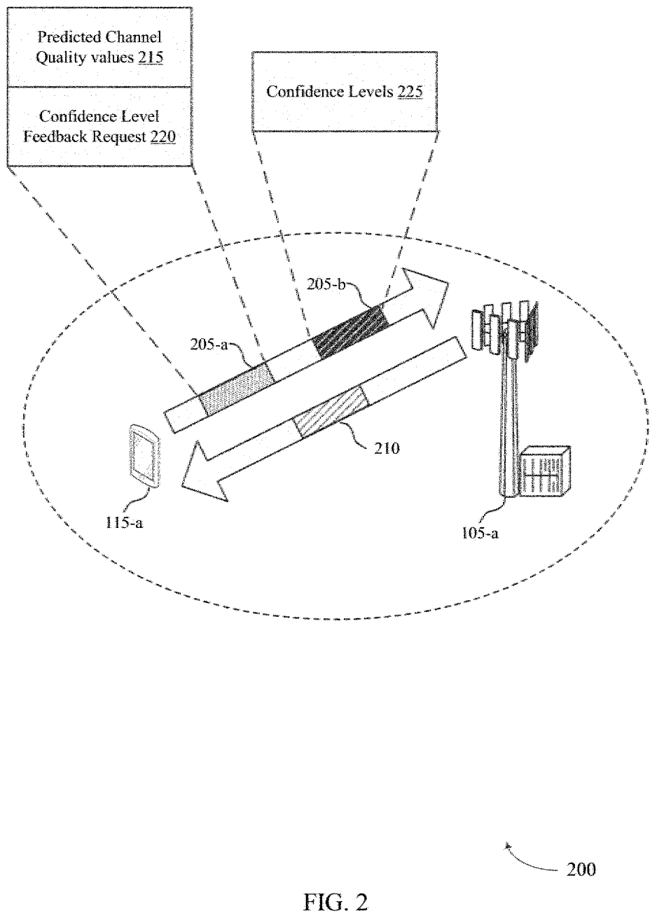

FIG. 2 illustrates an example of a wireless communications system 200 that supports asymmetric confidence level for predictive beam management in accordance with one or more aspects of the present disclosure. The wireless communications system 200 may implement aspects of, or may be implemented by aspects of, the wireless communications system 100. For example, the wireless communications system 200 may include a UE 115-a, and a network entity 105-a, which may be examples of corresponding devices described with reference to FIG. 2.

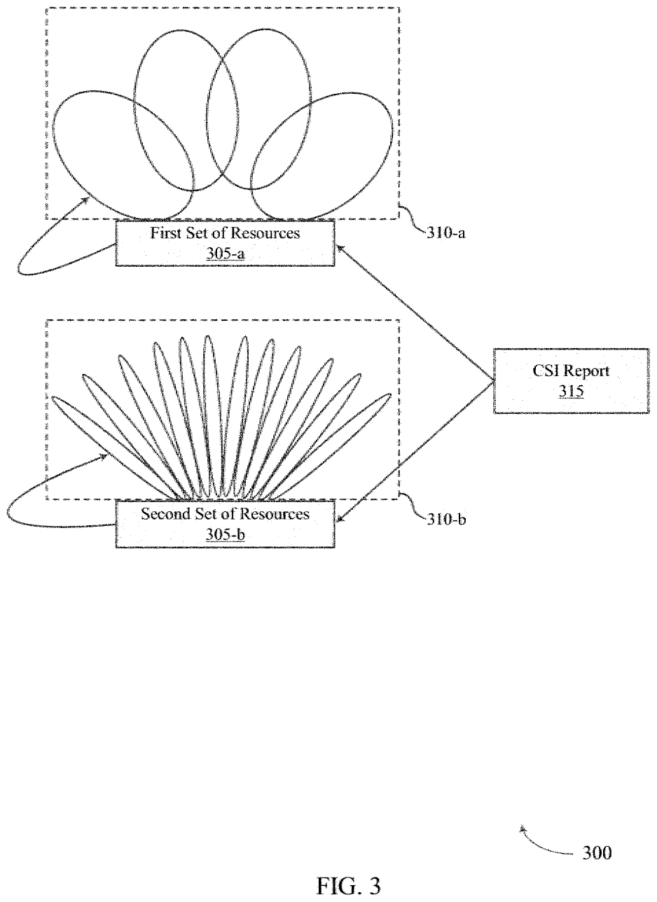

In some examples, the UE 115-a may perform channel measurements, and may generate predicted channel characteristic values for one or more resources, as described in greater detail with reference to FIG. 3. For example, the UE 115-a may receive one or more reference signals via one or more resources (e.g., CMRs, virtual resources, among other examples), and may perform one or more measurements via one or more beams. The UE 115-a may generate predicted channel characteristic values 215 (e.g., for one or more CMRs or virtual resources), which the UE 115-a may include in a first CSI report 205-a. The first CSI report 205-a may include the predicted channel characteristic values 215 and corresponding resource identifiers (IDs). The UE may transmit (e.g., in the first CSI report 205-a) a confidence level feedback request 220, and may receive a trigger 210 for a second CSI report 205-b.

In some examples, predicted channel quality values 215 may be associated with uncertainty, and it may be beneficial to report confidence levels 225 (e.g., defining the uncertainty) for each predicted channel quality values 215. For example, a predicted mean channel quality value (e.g., a L1 RSRP) may be accompanied with a standard deviation, as a confidence level. If a confidence level is medium (e.g., as opposed to high, or low), then the network entity 105-a may further schedule actual transmission of the beam predicted by the UE, or the network entity 105-a may select a conservative (e.g., lower) modulation and coding scheme (MCS) for PDSCH transmissions via beams corresponding to the predicted channel quality level and medium confidence level. The UE 115-a may also generate confidence values for each predicted channel quality value 215. Thus, the network entity 105-a may utilize such confidence values to determine one or more parameters for subsequent communications with the UE 115-a (e.g., a modulation and coding scheme (MCS), rate, beam selection, resource selection, etc.). In some examples, the network entity 105-a may determine whether to rely on predicted channel quality values 215 based on the confidence levels.

In some examples, the UE 115-a may confidence levels 225 according to a symmetric definition. For example, the predicted channel quality value 215 may be an L1-RSRP of −90 dB, and the UE 15-a may report that the actual LI-RSRP could be between a lower bound (e.g., −93 dB) and an upper bound (e.g., −87 dB) with a confidence level 225 (e.g., an 80 percent confidence level). For example, an 80 percent confidence level may be an example of a symmetric definition of the confidence level (e.g., an eighty percent confidence level that the actual RSRP is not below-93 dB or above 87 dB, respectively). If the confidence level 225 for the upper bound is wrong (e.g., inaccurate), subsequent communications between the network entity 105-a and the UE 115-a may not experience significant performance degradation (e.g., if the channel quality is actually higher than predicted, then scheduled communications will still perform as expected, or better than expected). However, when an actual channel quality (e.g., an actual L1-RSRP) is less than the predicted channel quality (e.g., a lower bound of the predicted L1-RSRP) risk of end-to-end performance degradation may increase (e.g., if the channel quality is worse than predicted, then communications scheduled based on the predicted channel quality may fail due to the poor channel quality, selected MCS, rate, rank, etc.). In such examples, instead of symmetric confidence level report, the network entity 105-a may more effectively schedule subsequent communication based on asymmetric confidence level reporting for UE based predictive beam management.

Techniques described herein may support asymmetric confidence level. Asymmetric confidence levels may be defined for reporting in association with LI beam characteristic predictions at the UE 115-a (e.g., in association with the predicted channel quality values 215). Techniques described herein may define a general frame work for reporting asymmetric confidence values, and opportunistic asymmetric confidence level reporting for uplink reporting overhead reduction. Such asymmetric confidence level reporting may be performed according to channel quality measurements and predictions as described with reference to FIG. 3.

FIG. 3 illustrates an example of a channel measurement scheme 300 that supports asymmetric confidence level for predictive beam management in accordance with one or more aspects of the present disclosure. The channel measurement scheme 300 may implement or may be implemented by aspects of the wireless communications systems 100 and 200. For example, the channel measurement scheme 300 may include a CSI report 315, which may be an example of a CSI report 205, or a CSI report 205-b, as described with reference to FIG. 2.

In some examples of beam management (e.g., AI-based, ML-based beam management), a network entity (e.g., the network entity 105-a) may configure a UE with two sets of beams for CSI measurement and prediction. The network entity may configure the UE with a first set of beams 310-a (e.g., set A). The UE may perform measurements on the first set of beams 310-a via the first set of resources 305-a (e.g., channel measurement resources (CMRs)). In some examples, the network entity may configure the UE with a second set of beams 310-b (e.g., set B). The UE may perform a beam prediction (e.g., spatial-domain downlink beam prediction, temporal downlink beam prediction) for the second set of beams 310-b based on measurement results, historic measurement results, or a combination thereof, of the first set of beams 310-a. In some cases, the UE may use a second set of resources 305-b (e.g., CMRs, virtual resources) to perform the beam prediction, and the second set of resources 305-b may correspond to the second set of beams 310-b. The UE may perform measurements using the set of beams 310-a and the set of beams 310-b via resources in the same frequency range or in different frequency ranges (e.g., the first set of resources 305-a and the second set of resources 305-b may partially overlap in frequency, completely overlap in frequency, may correspond to adjacent frequency ranges or frequency bands or subbands, or may be entirely different from each other).

In some examples, the first set of beams 310-a may be a subset of the second set of beams 310-b. In some examples, the first set of beams 310-a may have a same quantity of beams as the second set of beams 310-b, or the sets of beams 310 may have different quantities of beams. In some cases, the set of beams 310-a may be associated with the set of beams 310-b based on a fixed pattern, a random pattern, or a quasi-colocation relationship. The set of beams 310-a may have different characteristics than the set of beams 310-b. For example, the set of beams 310-a may be wide (e.g., coarse) beams and the set of beams 310-b may be narrow (e.g., fine) beams. In some examples, subsets of beams 310-b may correspond to individual coarse beams of the set of beams 310-b (e.g., three narrow beams of the set of beams 310-b may correspond to each coarse beam of the set of beams 310-a). The set of beams 310-a may be for downlink beam measurement, and the set of beams 310-b may be for DL beam prediction. The sets of beams 310 may be indicated by codebook constructions.

In some examples, a network entity may configure a UE for one or more serving cells (e.g., via RRC configuration). The configuration may include a codebook which may include sets of beams that may be formed by, or otherwise associated with, the first serving cell (e.g., the first set of beams 310-a, the second set of beams 310-b). The codebook may also include codepoints, and a network entity may use the codepoints in a cross-serving cell scheme to identify the first set of beams 310-a, the first set of resources 305-a, the second set of beams 310-b, the second set of resources 305-b, or a combination thereof. The codebook may include codebook indices where each resource of a set of resources 305 or each beam of a set of beams 310 is indicated by a unique codebook index. In some examples, the network entity may use the codepoints to indicate that the first set of resources 305-a and the second set of resources 305-b are associated with each other, or that the first set of beams 310-a and the second set of beams 310-b are associated with each other, or both.

The network entity may indicate or request that the UE transmits a CSI report associated with the first serving cell to the network entity, and the UE may transmit the CSI report 315 to the network entity. The UE may include in the CSI report 315 measurements of the first set of resources 305-a associated with the first set of beams 310-a, predicted measurements for the second set of resources 305-b associated with the second set of beams 310-b, or a combination thereof. The UE may indicate via the CSI report an association between measurements of the first set of resources 305-a and predicted measurements of the second set of resources 305-b (e.g., according to codepoints in the indicated codebook). In some examples, the UE may indicate preferred beams, optimal beams, or candidate beams from the sets of beams 310 via the CSI report by selecting codepoint indices in the codebook that correspond to the preferred beams, optimal beams, or candidate beams. In other examples, the UE may indicate preferred or candidate resources from the sets of resources 305 by selecting codepoint indices from the codebook that correspond to the preferred or candidate resources. By using codepoint indices to select beams or resources in the CSI report, the UE may support low RRC overhead, or flexibility to dynamically alter beam point directions or beam widths, or both.

In some cases, the CSI report, the set of beams 310-a (and corresponding set of resources 305-a), and the set of beams 310-b (and corresponding set of resources 305-b) may be associated with a single serving cell, or for multiple serving cells.

The UE may perform the predicted measurements (e.g., L1-RSRP, L1-SINR) based on associations between the first set of resources 305-a and the second set of resources 305-b. For example, the UE may perform one or more channel measurements via the first set of resources using the first set of beams according to the cross serving cell scheme. Based on the one or more channel measurements, the UE may transmit to the network entity (e.g., to the first serving cell) the CSI report 315 indicating predicted channel characteristic information (e.g., predicted measurements) for the second set of resources 305-b for the second set of beams 310-b associated with the second serving cell.

Associations between the set of resources 305-a and the set of resources 305-b may be separately configured or indicated in the first serving cell, the one or more second serving cells, or a combination thereof. For example, control signaling that indicates cross serving cell scheme may identify an association between the set of resources 305-a and the set of resources 305-b. In some cases, a codebook may indicate beams formable by, or otherwise associated with, the second serving cell (e.g., the set of beams 310-a, the set of beams 310-b for the second cell). The network entity may configure the UE with the codebook of beams formable by the second serving cell (e.g., via RRC configuration within the configuration information of the second serving cell).

The configuration may include the codebook, and the UE may identify associations between the first set of beams 310-a and the second set of beams 310-b of the second serving cell using beamforming codepoints within the codebook.

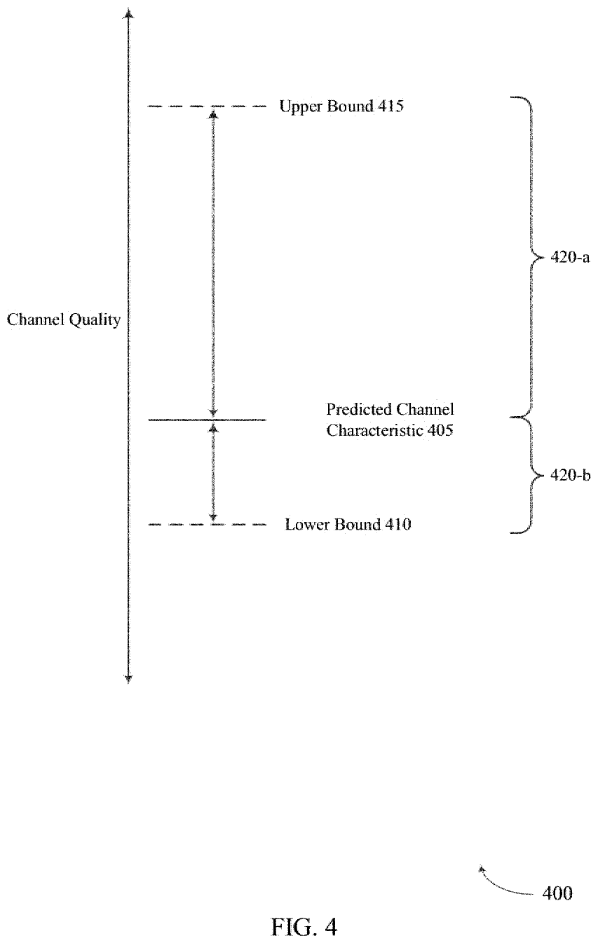

In some examples, as described herein, the UE may report asymmetric confidence levels via the CSI report 315 (e.g., instead of symmetric confidence levels), as described in greater detail with reference to FIG. 4.

FIG. 4 illustrates an example of a confidence level reporting scheme 400 that supports asymmetric confidence level for predictive beam management in accordance with one or more aspects of the present disclosure. The confidence level reporting scheme 400 may incorporate aspects of, or be incorporated by aspects of, the wireless communications system 100, the wireless communications system 200, the channel measurement scheme 300, or any combination thereof. For example, a network entity and a UE may communicate with each other according to the confidence level reporting scheme 400.

The UE may be requested to predict (e.g., in at least one of time domain, special domain, or frequency domain) channel characteristics (e.g., including at least one of L1-RSRP, L1-SINR, RI, or CQI) associated with a set of CMRs, or virtual resources (e.g., as described in greater detail with reference to FIG. 3). The UE may further identify asymmetric confidence levels associated with the predicted channel characteristics. The UE may report (e.g., via a first CSI report, a second CSI report, or both) the predicted channel characteristic 405 and the associated asymmetric confidence levels. In some examples, reporting symmetric confidence levels may be considered as a special case of asymmetric confidence levels (e.g., the UE may report a first confidence level associated with an upper bound and a second confidence level with a lower bound, and the two confidence values may be equal, resulting in a symmetric confidence level report).

The asymmetric confidence levels associated with a certain predicted channel characteristics quantity (e.g., the predicted channel characteristic 405) may be defined based on a confidence level associated with the actual channel characteristics quantity being higher than the predicted channel characteristic 405 (e.g., the upper bound 415), the confidence level associated with the actual channel characteristic quantity being lower than the predicted channel characteristic 405 (e.g., the lower bound 410). For example, the predicted channel characteristic 405 may be a mean L1-RSRP (e.g., −90 dBm). The confidence level 420-a for the actual L1-RSRP being not greater than the upper bound 415 (e.g., −87 dBm) may be 75 percent, and the confidence level 420-b for the actual LI-RSRP being not lower than the lower bound 410 (e.g., −93 dBm) may be 95 percent. In some examples, the predicted channel characteristic 405 may be a mean L1-SINR (e.g., 10 dB). The confidence level 420-a for the actual L1-SINR being not greater than the upper bound 415 (e.g., 13 dB) may be 75 percent, and the confidence level 420-b for the actual LI-SINR being not lower than the lower bound 410 (e.g., 7 dB) may be 95 percent. In some examples, the predicted channel characteristic 405 may be a mean rank (e.g., 3). The confidence level 420-a for the actual rank being not greater than the upper bound 415 (e.g., rank 4) may be 75 percent, and the confidence level 420-b for the actual rank being not lower than the lower bound 410 (e.g., rank 2) may be 95 percent. In some examples, the predicted channel characteristic 405 may be a mean CQI (e.g., 22). The confidence level 420-a for the actual CQI being not greater than the upper bound 415 (e.g., 26) may be 75 percent, and the confidence level 420-b for the actual CQI being not lower than the lower bound 410 (e.g., 18) may be 95 percent. The upper bound 415 and the lower bound 410 may be equidistance from the predicted channel characteristic 405 (e.g., but the confidence levels 420 for the upper bound 415 and the lower bound 410, respectively, may be different). In some examples, the upper bound 415 and the lower bound 410 may be offset from the predicted channel characteristic 405 by different quantities (e.g., a range from the predicted channel characteristic 405 to the upper bound 415 may be greater than, or less than, a range from the predicted channel characteristic 405 to the lower bound 410). In such examples, the confidence level 420-b may be higher than the confidence level 420-a (e.g., based on the difference in range).

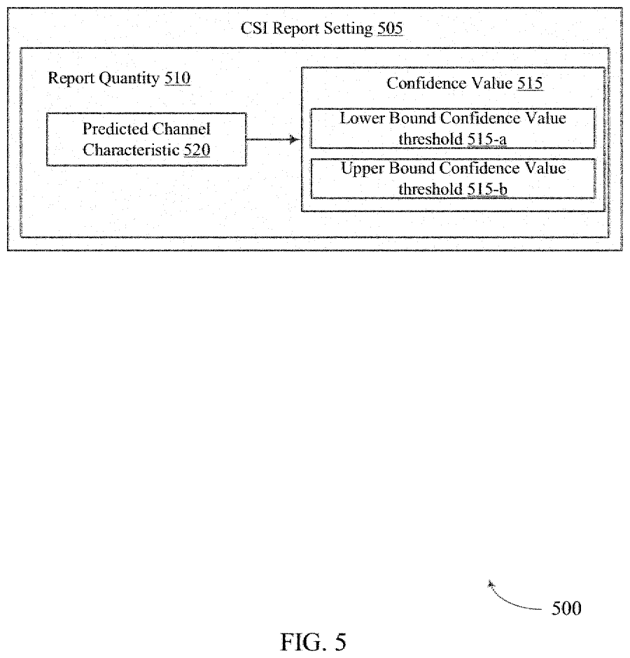

In some examples, as described in greater detail with reference to FIG. 5, the network entity may request that the UE report predicted channel characteristics 405 via a CSI report, a MAC-CE message, an RRC message, or any combination thereof. Such request may be configured via CSI report setting information, a MAC-CE message, an RRC message, or any combination thereof. The network may further request that the UE provided feedback information including asymmetric confidence levels associated with the reported channel characteristics. The CSI repot setting may indicate the upper bound 415, the lower bound 410, and a report quantity (e.g. reportQuantity) for each predicted channel characteristic 405 and associated asymmetric confidence levels 420 (e.g., a first confidence level 420-a associated with the upper bound 415, and a second confidence level 420-b associated with the lower bound 415).

IN some examples, the UE may report the asymmetric confidence levels 420 according to different granularity for the asymmetric confidence levels. The number of bits to quantize (e.g., a dynamic range for which to quantize) the confidence level 420-a (e.g., in terms of percentages) with respect to the actual channel characteristics quantity greater than the predicted channel characteristic 405 may be different from (e.g., greater than) the confidence level 420-b (e.g., in terms of percentage) with respect to the actual channel characteristics quantity lower than the predicted channel characteristic 405. For instance, a quantity of bits M (e.g., M=2) may be used to quantize the confidence level 420 in the range of fifty percent t ninety percent, for the case where the actual channel characteristic (e.g., an actual L1-RSRP) is a threshold (e.g., X dB) greater than the predicted L1-RSRP. A second quantity of bits N (e.g., N=4) may be used to quantize the confidence level (e.g., in the range of twenty-five percent to ninety-nine percent) for the case where the actual LI-RSRP is a threshold (e.g., Y dB) lower than the predicted L1-RSRP. The values of X and Y may be controlled by the network entity (e.g., may be configured by the network entity at the UE, or may be indicated in one or more standards documents). In some examples, the values of M and N, the dynamic ranges, or both, may be defined in the standard, or indicated by the network entity. In some examples, the UE may report a supported granularity, quantization, or dynamic range, or a combination thereof, via capability signaling, and the network may configure the values of M, N, the dynamic ranges, or a combination thereof, based on the reported capability (e.g., the network will not configure a granularity for reporting the confidence levels 420 that exceeds the threshold capability of the UE).

In some examples, the UE may perform asymmetric event triggered opportunistic asymmetric confidence level reporting. For example, the UE may use CSI repots to report predicted channel characteristics 405 (e.g., L1-RSRP, L1-SINIR, RIs, CQIs, etc.). The UE may use one or more bits to indicate whether it will further report confidence levels associated with one or more predicted channel characteristics 405. As described in greater detail with reference to FIG. 2, the UE may use a MAC-CE message or may be scheduled by the network with a separate CSI report to feedback such confidence levels 420. The indication that the UE has confidence values (e.g., that fail to satisfy a threshold) to report for a given predicted channel characteristic 405 may further indicate whether the UE will report confidence levels associated with the case where the actual channel quality characteristic is greater than the predicted one, or lower than the predicted one (e.g., or both). In some examples, the UE may autonomously use a MAC-CE message or an RRC message to report such confidence levels 420 directly (e.g., without such a preference indication).

In some examples, the indication that the UE requests to report confidence levels may be event-triggered. For example, the triggering event may be defined as a case in which the UE has identified a confidence level 420 that is higher than or lower than a predefined or configured threshold. For instance, the triggering event may include generating a confidence level 420-a that is lower than a first threshold (e.g., fifty percent, or a confidence level 420-b that is lower than a second threshold (e.g., eighty percent). In some examples, the network may configure the first threshold and the second threshold. In some examples, the second threshold may be higher than the first threshold (e.g., to increase the likelihood that the confidence level 420-b for the lower bound 410 remains high enough to ensure that the predicted channel characteristic 405 is not too much higher than the actual channel characteristic). For example, the even triggering the UE to carry out the feedback of confidence levels (e.g., the first threshold, the second threshold, or both) may be predefined, or may be configured by the network entity, differently for confidence levels 420-a where the actual channel characteristics quantity is greater than the predicted channel characteristic 405, than for the confidence level 420-b where the actual channel characteristics quantity is lower than the predicted one. The event may be triggered if the UE identifies a confidence level 420 that is less than a threshold percentage (e.g., fifty percent) for the case where the actual channel characteristic (e.g., an actual L1-RSRP) is not a X dB (e.g., X=12 dB) greater than the predicted channel characteristic 405. The event could be triggered if the UE identifies a confidence level less than N (e.g., N=80 percent) for the case where the actual L1-RSRP is not Y dB (e.g., Y=6 dB) weaker than the predicted channel characteristic 405. The values of M, N, X, and Y, may be defined in a standard, or may be configured by the network entity. For example, such values may be configured in a CSI report setting, or may be indicated in a MAC-CE message activating (e.g., semi-persistent) CSI reporting, or may be configured in CSI configuration information (e.g., a CSI-AssociatedReportConfigInfo) with respect to the second CSI report (e.g., an aperiodic CSI report). IN some examples, such values may be configured separately per serving cell, per BWP, per carrier, per carrier group, per set of frequency resources, among other examples.

FIG. 5 illustrates an example of a confidence level reporting scheme 500 that supports asymmetric confidence level for predictive beam management in accordance with one or more aspects of the present disclosure. The confidence level reporting scheme 500 may implement aspects of, or be implemented by aspects of, the wireless communications system 100, the wireless communications system 200, the channel measurement scheme 300, the confidence level reporting scheme 500, or any combination thereof. For example, a network entity and a UE may communicate with each other according to the confidence level reporting scheme 500.

The UE may perform asymmetric confidence level reporting according to a reporting framework as described herein. The UE predicted channel characteristics may be requested by the network entity (e.g., to be reported via a CSI report, a MAC-CE message, RRC signaling, or any combination thereof). The network entity may further request that the UE feedback asymmetric confidence levels associated with reported channel characteristics. For example, the network entity may request (e.g., via a CSI report setting 505) that the UE report predicted L1-RSRP, L1-SINR, quantities, among other examples, the CSI report setting 505 may further configure additional report quantities of the confidence levels (e.g., in terms of percentage) of the actual channel characteristics being less than a threshold (e.g., 12 dB) greater than the predicted channel characteristics, or the confidence levels (e.g., in terms of percentage) of the actual channel characteristics being less than a threshold (e.g., 6 dB) lower than the predicted one. In some examples, a MAC-CE message activating the CSI report (e.g., a semi-persistent CSI report) may further indicate threshold values (e.g., the upper bound threshold value, and the lower bound threshold value, such as 12 dB and 6 dB). In some examples, configuration information (e.g., a CSI-AssociatedReportConfigInfo message) with respect to an aperiodic CSI report may further configure the threshold values (e.g., a semi-persistent CSI report) may further indicate threshold values (e.g., the upper bound threshold value, and the lower bound threshold value, such as 12 dB and 6 dB). For instance, the CSI report setting 505 may include a report quantity 510 configuring the UE to report a predicted channel characteristic 520, and one or more confidence value 515 (e.g., the lower bound confidence value threshold 515-a, such as 6 dB, the upper bound confidence value threshold 515-b, such as 12 dB).

In some example, the network may only request for confidence levels of the actual channel characteristic being lower the threshold (e.g., 6 dB) lower than the predicted channel characteristic (e.g., but may not further request confidence levels of the actual channel characteristic being greater than the predicted channel characteristic). For instance, the network may request that the UE report the predicted channel characteristic 520 and the lower bound confidence value threshold 515-a corresponding to the predicted channel characteristic 520, but may not request that the UE report an upper bound confidence value threshold 515-b. In such examples, the UE may not report the upper bound confidence value threshold 515-b.

In some examples, the threshold values (e.g., the lower bound confidence value threshold 515-a and the upper bound confidence value threshold 515-b) may be defined in one or more standards documents.

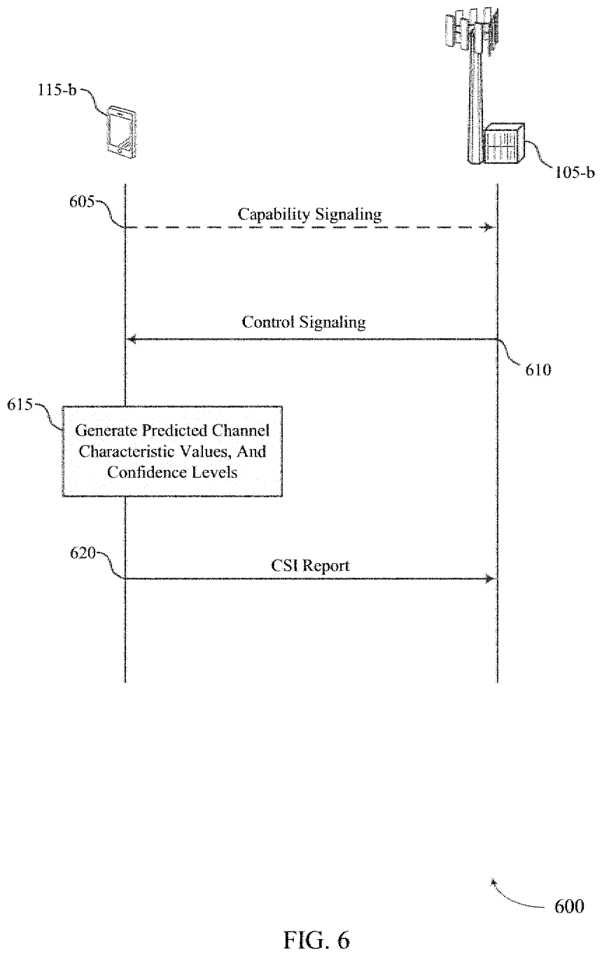

FIG. 6 illustrates an example of a process flow 600 that supports asymmetric confidence level for predictive beam management in accordance with one or more aspects of the present disclosure. The process flow 600 may implement aspects of, or be implemented by aspects of, the wireless communications system 100, the wireless communications system 200, the channel measurement scheme 300, the confidence level reporting scheme 500, or any combination thereof. For example, the process flow 600 may include a UE 115-b and a network entity 105-b, which may be examples of corresponding devices described herein.

At 610, the UE 115-b may receive, from the network entity 105-b, control signaling indicating an asymmetric confidence value reporting scheme for channel characteristics prediction for a resource (e.g., of a set of spatial resources, frequency resources, time resources, or a combination thereof). The asymmetric confidence value reporting scheme may indicate an upper bound for the channel characteristic prediction that is asymmetric to a lower bound for the channel characteristic prediction (e.g., as described with reference to FIG. 5).

In some examples, the UE 115-b may receive, via the control signaling, an indication of at least one of a first quantization level associated with the upper bound or a second quantization level associated with the lower bound, wherein the channel state information report indicates at least one of the upper bound confidence value based at least in part on the first quantization level or the lower bound confidence value based at least in part on the second quantization level. In some examples, at 605, the UE 115-b may transmit capability information indicating at least one of the first quantization level or the second quantization level, where receiving the indication of at least one of the first quantization level or the second quantization level (e.g., at 610) is based at least in part on the capability information. In some examples, the first quantization level corresponds to a first quantity of bits and the second quantization level corresponds to a second quantity of bits.

At 615, the UE 115-b may generate, according to the asymmetric confidence value reporting scheme, a first predicted channel characteristic value for the resource, and at least one of an upper bound confidence value for the first predicted channel characteristic value or a lower bound confidence value for the first predicted channel characteristic value.

At 620, the UE 115-b may transmit a CSI report indicating the first predicted channel characteristic value and at least one of the upper bound confidence value (e.g., a percentage confidence level that the actual channel characteristic is no more than a threshold (e.g., 12 dB) higher than the predicted channel characteristic) or the lower bound confidence value (e.g., a percentage confidence level that the actual channel characteristic is no more than a threshold (e.g., 6 dB) lower than the predicted channel characteristic) for the first predicted channel characteristic value. In some examples, the UE 115-b may transmit, via the CSI report, an indication of both the upper bound confidence value and the lower bound confidence value, and the lower bound confidence value may be different than the upper bound confidence value. In some examples, the control signaling received at 610 (e.g., a CSI report setting message) may indicate that the UE is to report the first predicted channel characteristic value and the lower bound confidence value (e.g., but not the upper bound confidence value. In such examples, the UE 115-b may transmit the CSI report to include just the lower bound confidence value (e.g., but not the upper bound confidence value).

In some examples (e.g., at 620), the UE 115-b may transmit a first CSI report message including a set of predicted channel characteristic values including the first predicted channel characteristic value and a confidence value feedback request, and the UE 115-b may also transmit a second CSI report message including a set of asymmetric confidence values corresponding to the set of predicted channel characteristic values based at least in part on the confidence value feedback request, the set of asymmetric confidence values including the upper bound confidence value, the lower bound confidence value, or a combination thereof. In such examples, the control signaling received at 610, or other control signaling, may include an indication of a threshold confidence level. Transmitting the first CSI report message including the confidence value feedback request may be based at least in part on at least one of the upper bound confidence value or the lower bound confidence value satisfying the threshold confidence level.

The CSI report may include multiple predicted channel characteristic values for multiple resources, and asymmetric confidence levels for each predicted channel characteristic value. The channel characteristic may include an RSRP, an SINR, an RI, a CWI, or any combination thereof. The predicted channel characteristic value, the upper bound confidence level, the lower bound confidence level, or any combination thereof, may be based at least in part on the resources in a frequency domain, a time domain, a spatial domain, or any combination thereof.

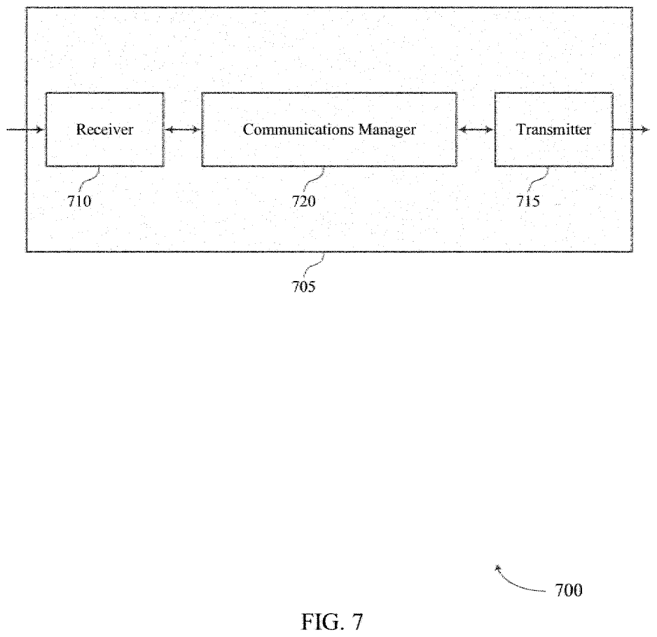

FIG. 7 illustrates a block diagram 700 of a device 705 that supports asymmetric confidence level for predictive beam management in accordance with one or more aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the asymmetric confidence level reporting for predictive beam management features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to asymmetric confidence level for predictive beam management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to asymmetric confidence level for predictive beam management). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of asymmetric confidence level for predictive beam management as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The communications manager 720 may be configured as or otherwise support a means for generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The communications manager 720 may be configured as or otherwise support a means for transmitting a channel state information report indicating the first predicted channel characteristic value and at least one of the upper bound confidence value or the lower bound confidence value for the first predicted channel characteristic value.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for confidence level reporting resulting in reduced processing at a device, improved reliability of wireless signaling, reduced signaling overhead, and improved user experience.

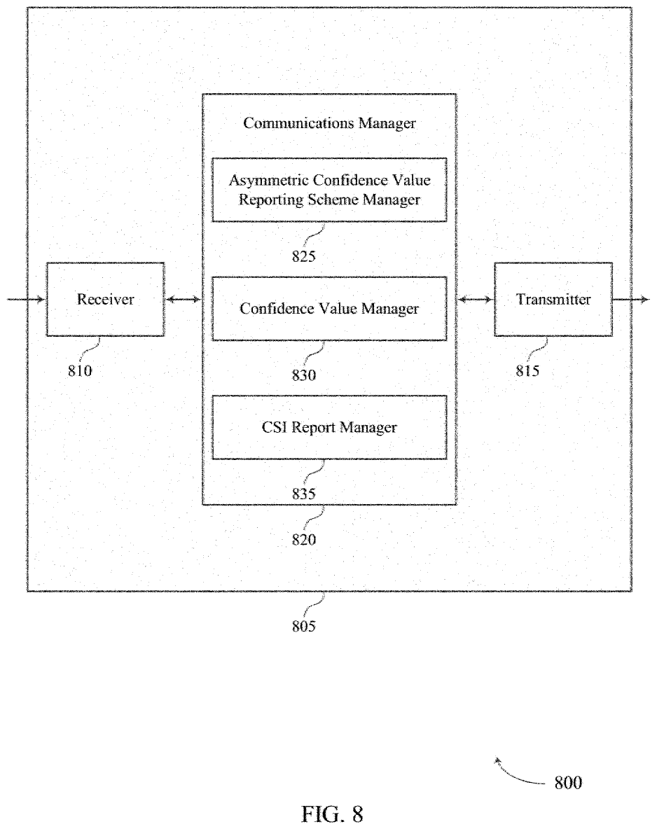

FIG. 8 illustrates a block diagram 800 of a device 805 that supports asymmetric confidence level for predictive beam management in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to asymmetric confidence level for predictive beam management). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to asymmetric confidence level for predictive beam management). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of asymmetric confidence level for predictive beam management as described herein. For example, the communications manager 820 may include an asymmetric confidence value reporting scheme manager 825, a confidence value manager 830, a CSI report manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The asymmetric confidence value reporting scheme manager 825 may be configured as or otherwise support a means for receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The confidence value manager 830 may be configured as or otherwise support a means for generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The CSI report manager 835 may be configured as or otherwise support a means for transmitting a channel state information report indicating the first predicted channel characteristic value and at least one of the upper bound confidence value or the lower bound confidence value for the first predicted channel characteristic value.

In some cases, the asymmetric confidence value reporting scheme manager 825, the confidence value manager 830, and the CSI report manager 835, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the asymmetric confidence value reporting scheme manager 825, the confidence value manager 830, and the CSI report manager 835 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

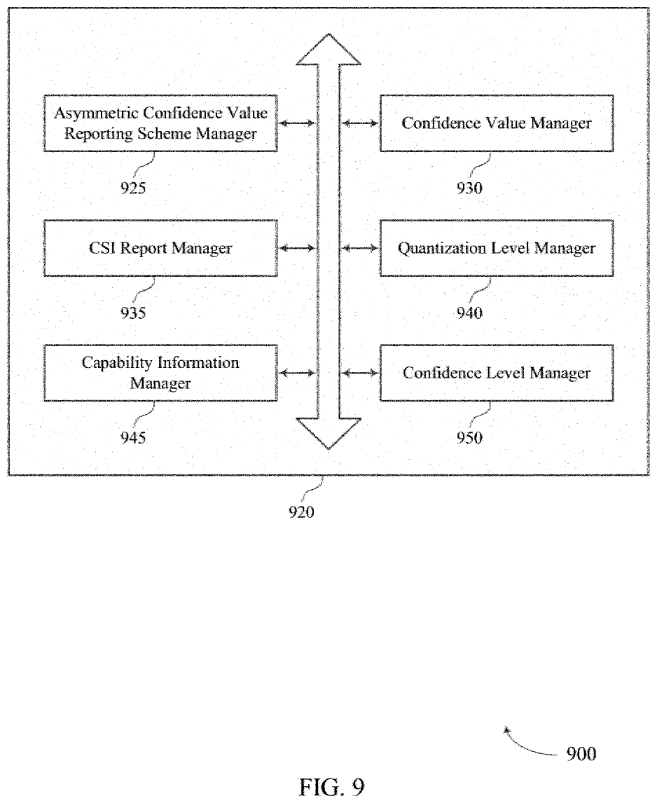

FIG. 9 illustrates a block diagram 900 of a communications manager 920 that supports asymmetric confidence level for predictive beam management in accordance with one or more aspects of the present disclosure. The communications manager 920 may be an example of aspects of a communications manager 720, a communications manager 820, or both, as described herein. The communications manager 920, or various components thereof, may be an example of means for performing various aspects of asymmetric confidence level for predictive beam management as described herein. For example, the communications manager 920 may include an asymmetric confidence value reporting scheme manager 925, a confidence value manager 930, a CSI report manager 935, a quantization level manager 940, a capability information manager 945, a confidence level manager 950, or any combination thereof. Each of these components may communicate, directly or indirectly, with one another (e.g., via one or more buses).

The communications manager 920 may support wireless communications at a UE in accordance with examples as disclosed herein. The asymmetric confidence value reporting scheme manager 925 may be configured as or otherwise support a means for receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The confidence value manager 930 may be configured as or otherwise support a means for generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The CSI report manager 935 may be configured as or otherwise support a means for transmitting a channel state information report indicating the first predicted channel characteristic value and at least one of the upper bound confidence value or the lower bound confidence value for the first predicted channel characteristic value.

In some examples, to support transmitting the channel state information report, the CSI report manager 935 may be configured as or otherwise support a means for transmitting the channel state information report that indicates both the upper bound confidence value and the lower bound confidence value, where the lower bound confidence value is different than the upper bound confidence value.

In some examples, the confidence value manager 930 may be configured as or otherwise support a means for receiving, via the control signaling, an instruction to report a single confidence value associated with the lower bound, where the channel state information report indicates the first predicted channel characteristic value and the lower bound confidence value.

In some examples, the quantization level manager 940 may be configured as or otherwise support a means for receiving, via the control signaling, an indication of at least one of a first quantization level associated with the upper bound or a second quantization level associated with the lower bound, where the channel state information report indicates at least one of the upper bound confidence value based on the first quantization level or the lower bound confidence value based on the second quantization level.

In some examples, the capability information manager 945 may be configured as or otherwise support a means for transmitting capability information indicating at least one of the first quantization level or the second quantization level, where receiving the indication of at least one of the first quantization level or the second quantization level is based on the capability information.

In some examples, the first quantization level corresponds to a first quantity of bits and the second quantization level corresponds to a second quantity of bits.

In some examples, to support transmitting the channel state information report, the CSI report manager 935 may be configured as or otherwise support a means for transmitting a first channel state information report message including a set of multiple predicted channel characteristic values including the first predicted channel characteristic value and a confidence value feedback request. In some examples, to support transmitting the channel state information report, the CSI report manager 935 may be configured as or otherwise support a means for transmitting a second channel state information report message including a set of multiple asymmetric confidence values corresponding to the set of multiple predicted channel characteristic values based on the confidence value feedback request, the set of multiple asymmetric confidence values including the upper bound confidence value, the lower bound confidence value, or both.

In some examples, the confidence level manager 950 may be configured as or otherwise support a means for receiving control signaling including an indication of a threshold confidence level, where transmitting the first channel state information report message including the confidence value feedback request is based on at least one of the upper bound confidence value or the lower bound confidence value satisfying the threshold confidence level.

In some examples, the CSI report manager 935 may be configured as or otherwise support a means for transmitting, via the channel state information report, a set of multiple predicted channel characteristic values corresponding to a set of multiple resources including the resource, and a set of confidence values, at least one confidence value of the set of confidence values corresponding to at least one predicted channel characteristic value of the set of multiple predicted channel characteristic values, where the set of multiple predicted channel characteristic values includes the first predicted channel characteristic value, and the set of confidence values includes the upper bound confidence value and the lower bound confidence value.

In some examples, a channel characteristic include a reference signal receive power, a signal to interference and noise ratio, a rank indicator, a channel quality information, or any combination thereof.

In some examples, the predicted channel characteristic value, the upper bound confidence value, the lower bound confidence value, or any combination thereof, is based on the resources in a frequency domain, a time domain, a spatial domain, or any combination thereof.

In some examples, the asymmetric confidence value reporting scheme manager 925, the confidence value manager 930, the CSI report manager 935, the Quantization level manager 940, the capability information manager 945, and the confidence level manager 950 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the asymmetric confidence value reporting scheme manager 925, the confidence value manager 930, the CSI report manager 935, the Quantization level manager 940, the capability information manager 945, and the confidence level manager 950 discussed herein.

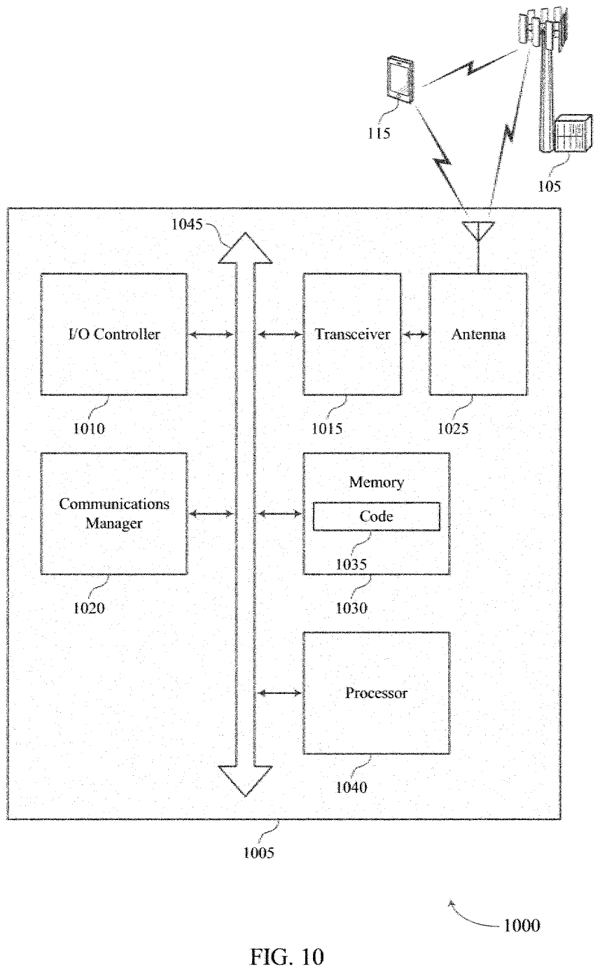

FIG. 10 illustrates a diagram of a system 1000 including a device 1005 that supports asymmetric confidence level for predictive beam management in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROIDR, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting asymmetric confidence level for predictive beam management). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The communications manager 1020 may be configured as or otherwise support a means for generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The communications manager 1020 may be configured as or otherwise support a means for transmitting a channel state information report indicating the first predicted channel characteristic value and at least one of the upper bound confidence value or the lower bound confidence value for the first predicted channel characteristic value.

By including or configuring the communications manager 1020 in accordance with examples as described herein, the device 1005 may support techniques for confidence level reporting resulting in reduced processing at a device, improved reliability of wireless signaling, reduced signaling overhead, more efficient use of available system resources, improved throughput, and improved user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of asymmetric confidence level for predictive beam management as described herein, or the processor 1040 and the memory 1030 may be otherwise configured to perform or support such operations.

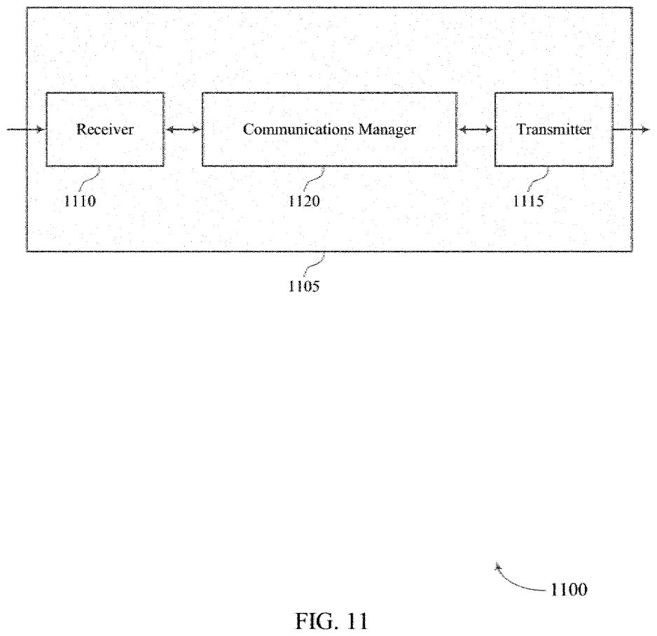

FIG. 11 illustrates a block diagram 1100 of a device 1105 that supports asymmetric confidence level for predictive beam management in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include one or more processors, and instructions stored in the memory that are executable by the one or more processors to enable the one or more processors to perform the asymmetric confidence level reporting for predictive beam management features discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of asymmetric confidence level for predictive beam management as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction. The communications manager 1120 may be configured as or otherwise support a means for transmitting one or more reference signals via the resource. The communications manager 1120 may be configured as or otherwise support a means for receiving a channel state information report indicating a first predicted channel characteristic value and at least one of an upper bound confidence value or a lower bound confidence value for the first predicted channel characteristic value.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for confidence level reporting resulting in reduced processing at a device, improved reliability of wireless signaling, reduced signaling overhead, and improved user experience.

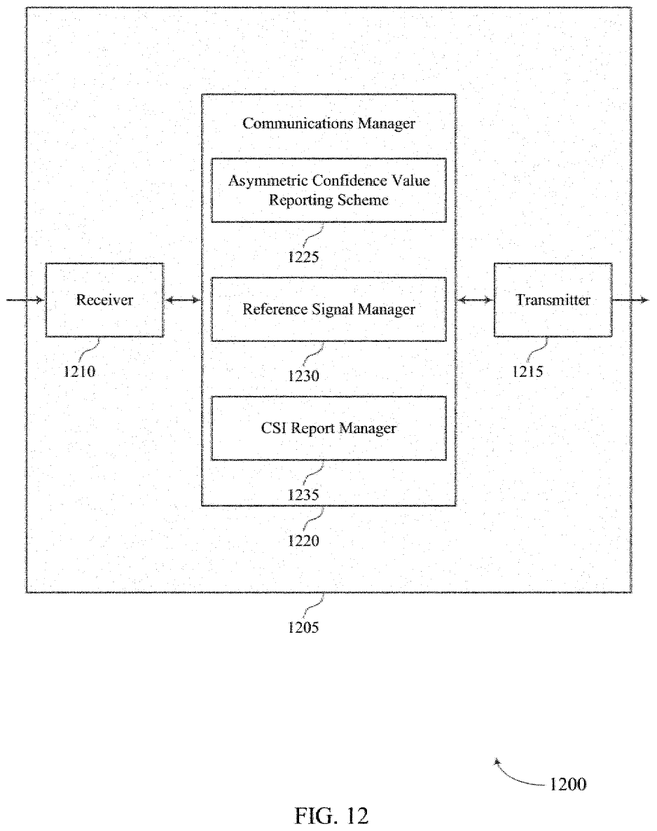

FIG. 12 illustrates a block diagram 1200 of a device 1205 that supports asymmetric confidence level for predictive beam management in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas.

Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of asymmetric confidence level for predictive beam management as described herein. For example, the communications manager 1220 may include an asymmetric confidence value reporting scheme 1225, a reference signal manager 1230, a CSI report manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The asymmetric confidence value reporting scheme 1225 may be configured as or otherwise support a means for transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction. The reference signal manager 1230 may be configured as or otherwise support a means for transmitting one or more reference signals via the resource. The CSI report manager 1235 may be configured as or otherwise support a means for receiving a channel state information report indicating a first predicted channel characteristic value and at least one of an upper bound confidence value or a lower bound confidence value for the first predicted channel characteristic value.

IN some cases, the asymmetric confidence value reporting scheme manager 1225, the reference signal manager 1230, and the CSI report manager 1235 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the asymmetric confidence value reporting scheme manager 1225, the reference signal manager 1230, and the CSI report manager 1235 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

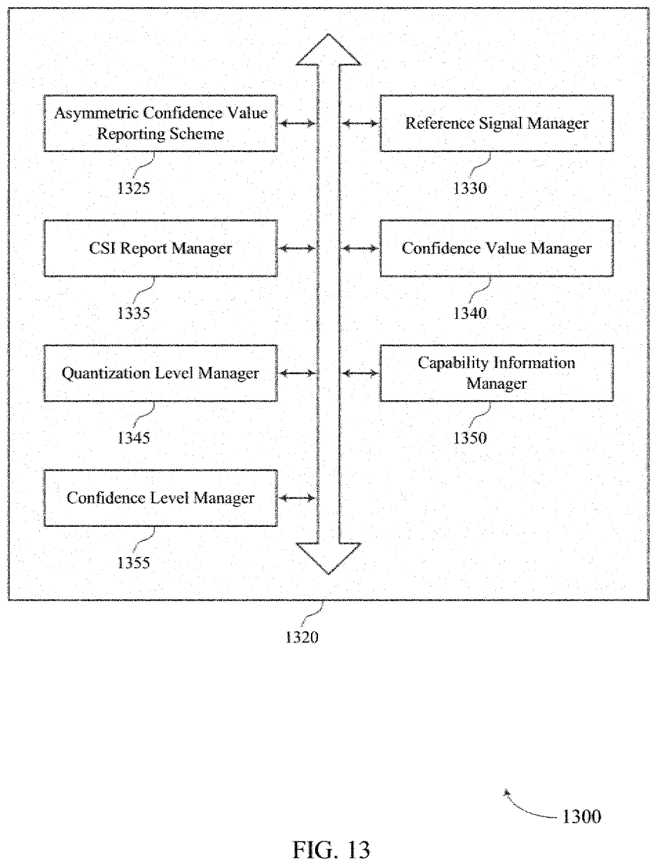

FIG. 13 illustrates a block diagram 1300 of a communications manager 1320 that supports asymmetric confidence level for predictive beam management in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of asymmetric confidence level for predictive beam management as described herein. For example, the communications manager 1320 may include an asymmetric confidence value reporting scheme 1325, a reference signal manager 1330, a CSI report manager 1335, a confidence value manager 1340, a quantization level manager 1345, a capability information manager 1350, a confidence level manager 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The asymmetric confidence value reporting scheme 1325 may be configured as or otherwise support a means for transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction. The reference signal manager 1330 may be configured as or otherwise support a means for transmitting one or more reference signals via the resource. The CSI report manager 1335 may be configured as or otherwise support a means for receiving a channel state information report indicating a first predicted channel characteristic value and at least one of an upper bound confidence value or a lower bound confidence value for the first predicted channel characteristic value.

In some examples, to support receiving the channel state information report, the CSI report manager 1335 may be configured as or otherwise support a means for receiving the channel state information report that indicates both the upper bound confidence value and the lower bound confidence value, where the lower bound confidence value is different than the upper bound confidence value.

In some examples, the confidence value manager 1340 may be configured as or otherwise support a means for transmitting, via the control signaling, an instruction to report a single confidence value associated with the lower bound, where the channel state information report indicates the first predicted channel characteristic value and the lower bound confidence value.

In some examples, the quantization level manager 1345 may be configured as or otherwise support a means for transmitting, via the control signaling, an indication of at least one of a first quantization level associated with the upper bound or a second quantization level associated with the lower bound, where the channel state information report indicates at least one of the upper bound confidence value based on the first quantization level or the lower bound confidence value based on the first quantization level and the second quantization level.

In some examples, the capability information manager 1350 may be configured as or otherwise support a means for receiving capability information indicating at least one of the first quantization level or the second quantization level, where transmitting the indication of at least one of the first quantization level or the second quantization level is based on the capability information.

In some examples, the first quantization level corresponds to a first quantity of bits and the second quantization level corresponds to a second quantity of bits.

In some examples, to support receiving the channel state information report, the CSI report manager 1335 may be configured as or otherwise support a means for receiving a first channel state information report message including a set of multiple predicted channel characteristic values including the first predicted channel characteristic value and a confidence value feedback request. In some examples, to support receiving the channel state information report, the CSI report manager 1335 may be configured as or otherwise support a means for receiving a second channel state information report message including a set of multiple asymmetric confidence values corresponding to the set of multiple predicted channel characteristic values based on the confidence value feedback request, the set of multiple asymmetric confidence values including the upper bound confidence value, the lower bound confidence value, or both.

In some examples, the confidence level manager 1355 may be configured as or otherwise support a means for transmitting control signaling including an indication of a threshold confidence level, where receiving the first channel state information report message including the confidence value feedback request is based on at least one of the upper bound confidence value or the lower bound confidence value satisfying the threshold confidence level.

In some examples, the CSI report manager 1335 may be configured as or otherwise support a means for receiving, via the channel state information report, a set of multiple predicted channel characteristic values corresponding to a set of multiple resources, and a set of confidence values, at least one confidence value of the set of confidence values corresponding to each predicted channel characteristic value of the set of multiple predicted channel characteristic values, where the set of multiple predicted channel characteristic values includes the first predicted channel characteristic value, and the set of confidence values includes the upper bound confidence value and the lower bound confidence value.

In some examples, a channel characteristic include a reference signal receive power, a signal to interference and noise ratio, a rank indicator, a channel quality information, or any combination thereof.

In some examples, the predicted channel characteristic value, the upper bound confidence value, the lower bound confidence value, or any combination thereof, is based on the resources in a frequency domain, a time domain, a spatial domain, or any combination thereof.

In some cases, the asymmetric confidence value reporting scheme 1325, the reference signal manager 1330, the CSI report manager 1335, the confidence value manager 1340, the quantization level manager 1345, the capability information manager 1350, and the confidence level manager 1355 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the asymmetric confidence value reporting scheme 1325, the reference signal manager 1330, the CSI report manager 1335, the confidence value manager 1340, the quantization level manager 1345, the capability information manager 1350, and the confidence level manager 1355 discussed herein.

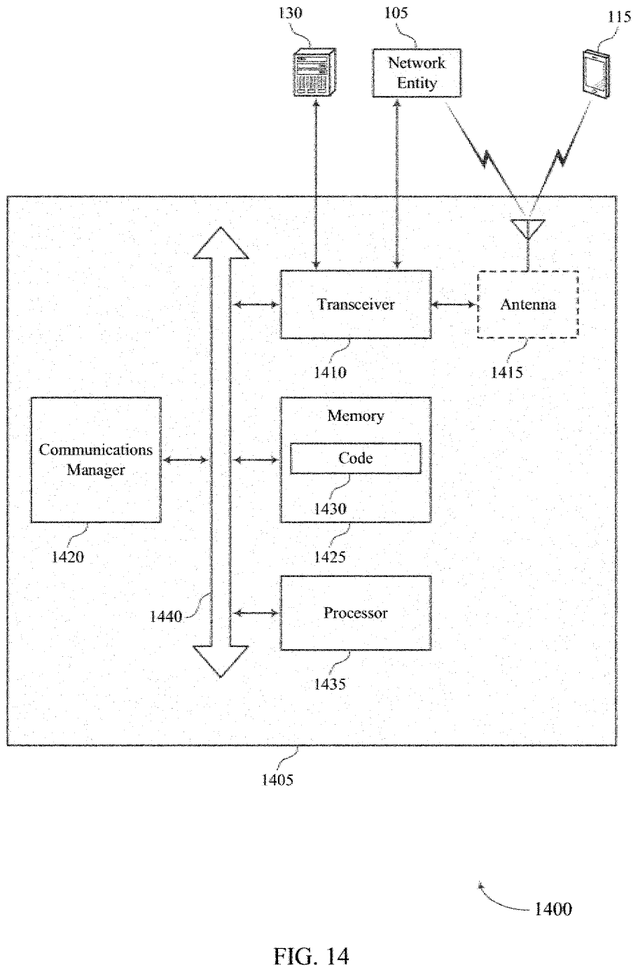

FIG. 14 illustrates a diagram of a system 1400 including a device 1405 that supports asymmetric confidence level for predictive beam management in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting asymmetric confidence level for predictive beam management). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction.

The communications manager 1420 may be configured as or otherwise support a means for transmitting one or more reference signals via the resource. The communications manager 1420 may be configured as or otherwise support a means for receiving a channel state information report indicating a first predicted channel characteristic value and at least one of an upper bound confidence value or a lower bound confidence value for the first predicted channel characteristic value.

By including or configuring the communications manager 1420 in accordance with examples as described herein, the device 1405 may support techniques for confidence level reporting resulting in reduced processing at a device, improved reliability of wireless signaling, reduced signaling overhead, more efficient use of available system resources, improved throughput, and improved user experience.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of asymmetric confidence level for predictive beam management as described herein, or the processor 1435 and the memory 1425 may be otherwise configured to perform or support such operations.

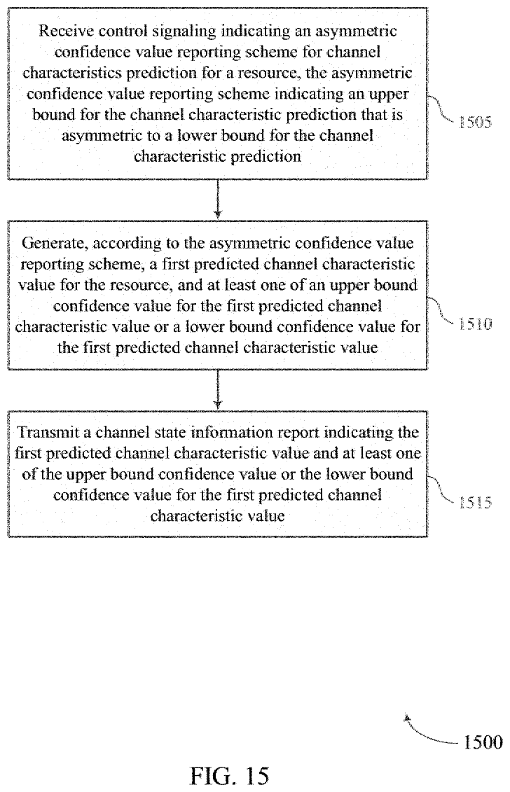

FIG. 15 illustrates a flowchart showing a method 1500 that supports asymmetric confidence level for predictive beam management in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The operations of 1505 may be performed in accordance with examples as disclosed herein. In some examples, aspects of the operations of 1505 may be performed by an asymmetric confidence value reporting scheme manager 925 as described with reference to FIG. 9.

At 1510, the method may include generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The operations of 1510 may be performed in accordance with examples as disclosed herein. In some examples, aspects of the operations of 1510 may be performed by a confidence value manager 930 as described with reference to FIG. 9.

At 1515, the method may include transmitting a channel state information report indicating the first predicted channel characteristic value and at least one of the upper bound confidence value or the lower bound confidence value for the first predicted channel characteristic value. The operations of 1515 may be performed in accordance with examples as disclosed herein. In some examples, aspects of the operations of 1515 may be performed by a CSI report manager 935 as described with reference to FIG. 9.

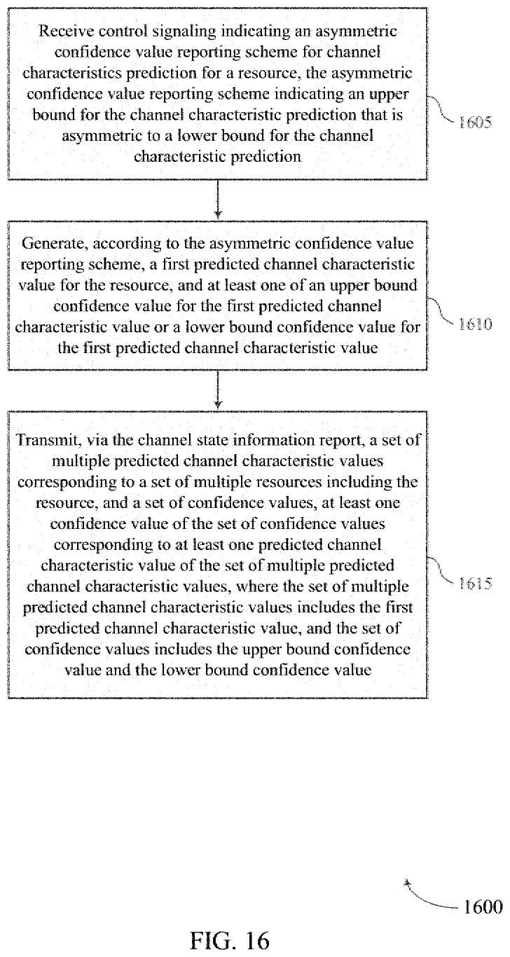

FIG. 16 illustrates a flowchart showing a method 1600 that supports asymmetric confidence level for predictive beam management in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction. The operations of 1605 may be performed in accordance with examples as disclosed herein. In some examples, aspects of the operations of 1605 may be performed by an asymmetric confidence value reporting scheme manager 925 as described with reference to FIG. 9.

At 1610, the method may include generating, according to the asymmetric confidence value reporting scheme, a first predicted channel characteristic value for the resource, and at least one of an upper bound confidence value for the first predicted channel characteristic value or a lower bound confidence value for the first predicted channel characteristic value. The operations of 1610 may be performed in accordance with examples as disclosed herein. In some examples, aspects of the operations of 1610 may be performed by a confidence value manager 930 as described with reference to FIG. 9.

At 1615, the method may include transmitting, via the channel state information report, a set of multiple predicted channel characteristic values corresponding to a set of multiple resources including the resource, and a set of confidence values, at least one confidence value of the set of confidence values corresponding to at least one predicted channel characteristic value of the set of multiple predicted channel characteristic values, where the set of multiple predicted channel characteristic values includes the first predicted channel characteristic value, and the set of confidence values includes the upper bound confidence value and the lower bound confidence value. The operations of 1620 may be performed in accordance with examples as disclosed herein. In some examples, aspects of the operations of 1620 may be performed by a CSI report manager 935 as described with reference to FIG. 9.

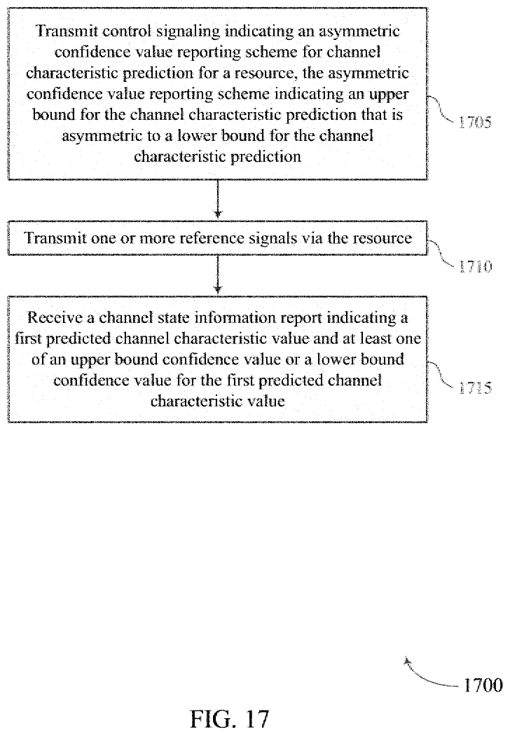

FIG. 17 illustrates a flowchart showing a method 1700 that supports asymmetric confidence level for predictive beam management in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction. The operations of 1705 may be performed in accordance with examples as disclosed herein. In some examples, aspects of the operations of 1705 may be performed by an asymmetric confidence value reporting scheme 1325 as described with reference to FIG. 13.

At 1710, the method may include transmitting one or more reference signals via the resource. The operations of 1710 may be performed in accordance with examples as disclosed herein. In some examples, aspects of the operations of 1710 may be performed by a reference signal manager 1330 as described with reference to FIG. 13.

At 1715, the method may include receiving a channel state information report indicating a first predicted channel characteristic value and at least one of an upper bound confidence value or a lower bound confidence value for the first predicted channel characteristic value. The operations of 1715 may be performed in accordance with examples as disclosed herein. In some examples, aspects of the operations of 1715 may be performed by a CSI report manager 1335 as described with reference to FIG. 13.

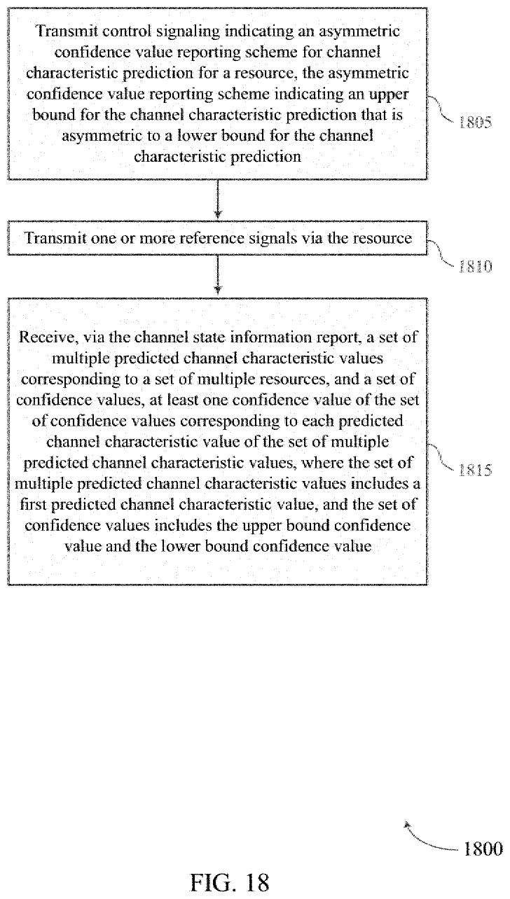

FIG. 18 illustrates a flowchart showing a method 1800 that supports asymmetric confidence level for predictive beam management in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction. The operations of 1805 may be performed in accordance with examples as disclosed herein. In some examples, aspects of the operations of 1805 may be performed by an asymmetric confidence value reporting scheme 1325 as described with reference to FIG. 13.

At 1810, the method may include transmitting one or more reference signals via the resource. The operations of 1810 may be performed in accordance with examples as disclosed herein. In some examples, aspects of the operations of 1810 may be performed by a reference signal manager 1330 as described with reference to FIG. 13.

At 1815, the method may include receiving, via the channel state information report, a set of multiple predicted channel characteristic values corresponding to a set of multiple resources, and a set of confidence values, at least one confidence value of the set of confidence values corresponding to each predicted channel characteristic value of the set of multiple predicted channel characteristic values, where the set of multiple predicted channel characteristic values includes a first predicted channel characteristic value, and the set of confidence values includes the upper bound confidence value and the lower bound confidence value. The operations of 1820 may be performed in accordance with examples as disclosed herein. In some examples, aspects of the operations of 1820 may be performed by a CSI report manager 1335 as described with reference to FIG. 13.

The following provides an overview of aspects of the present disclosure:

Aspect 1: A method for wireless communications at a UE, comprising: receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction; generating, according to the asymmetric confidence value reporting scheme, a first predicted channel characteristic value for the resource, and at least one of an upper bound confidence value for the first predicted channel characteristic value or a lower bound confidence value for the first predicted channel characteristic value; and transmitting a channel state information report indicating the first predicted channel characteristic value and at least one of the upper bound confidence value or the lower bound confidence value for the first predicted channel characteristic value.

Aspect 2: The method of aspect 1, wherein transmitting the channel state information report comprises: transmitting the channel state information report that indicates both the upper bound confidence value and the lower bound confidence value, wherein the lower bound confidence value is different than the upper bound confidence value.

Aspect 3: The method of any of aspects 1 through 2, further comprising: receiving, via the control signaling, an instruction to report a single confidence value associated with the lower bound, wherein the channel state information report indicates the first predicted channel characteristic value and the lower bound confidence value.

Aspect 4: The method of any of aspects 1 through 3, further comprising: receiving, via the control signaling, an indication of at least one of a first quantization level associated with the upper bound or a second quantization level associated with the lower bound, wherein the channel state information report indicates at least one of the upper bound confidence value based at least in part on the first quantization level or the lower bound confidence value based at least in part on the second quantization level.

Aspect 5: The method of aspect 4, further comprising: transmitting capability information indicating at least one of the first quantization level or the second quantization level, wherein receiving the indication of at least one of the first quantization level or the second quantization level is based at least in part on the capability information.

Aspect 6: The method of any of aspects 4 through 5, wherein the first quantization level corresponds to a first quantity of bits and the second quantization level corresponds to a second quantity of bits.

Aspect 7: The method of any of aspects 1 through 6, wherein transmitting the channel state information report comprises: transmitting a first channel state information report message comprising a plurality of predicted channel characteristic values comprising the first predicted channel characteristic value and a confidence value feedback request; and transmitting a second channel state information report message comprising a plurality of asymmetric confidence values corresponding to the plurality of predicted channel characteristic values based at least in part on the confidence value feedback request, the plurality of asymmetric confidence values comprising the upper bound confidence value, the lower bound confidence value, or both.

Aspect 8: The method of aspect 7, further comprising: receiving control signaling comprising an indication of a threshold confidence level, wherein transmitting the first channel state information report message comprising the confidence value feedback request is based at least in part on at least one of the upper bound confidence value or the lower bound confidence value satisfying the threshold confidence level.

Aspect 9: The method of any of aspects 1 through 8, further comprises: transmitting, via the channel state information report, a plurality of predicted channel characteristic values corresponding to a plurality of resources comprising the resource, and a set of confidence values, at least one confidence value of the set of confidence values corresponding to at least one predicted channel characteristic value of the plurality of predicted channel characteristic values, wherein the plurality of predicted channel characteristic values comprises the first predicted channel characteristic value, and the set of confidence values comprises the upper bound confidence value and the lower bound confidence value.

Aspect 10: The method of any of aspects 1 through 9, wherein a channel characteristic comprise a reference signal receive power, a signal to interference and noise ratio, a rank indicator, a channel quality information, or any combination thereof.

Aspect 11: The method of any of aspects 1 through 10, wherein the predicted channel characteristic value, the upper bound confidence level, the lower bound confidence level, or any combination thereof, is based at least in part on the resources in a frequency domain, a time domain, a spatial domain, or any combination thereof.

Aspect 12: A method for wireless communications at a network entity, comprising: transmitting control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction; transmitting one or more reference signals via the resource; and receiving a channel state information report indicating a first predicted channel characteristic value and at least one of an upper bound confidence value or a lower bound confidence value for the first predicted channel characteristic value.

Aspect 13: The method of aspect 12, wherein receiving the channel state information report comprises: receiving the channel state information report that indicates both the upper bound confidence value and the lower bound confidence value, wherein the lower bound confidence value is different than the upper bound confidence value.

Aspect 14: The method of any of aspects 12 through 13, further comprising: transmitting, via the control signaling, an instruction to report a single confidence value associated with the lower bound, wherein the channel state information report indicates the first predicted channel characteristic value and the lower bound confidence value.

Aspect 15: The method of any of aspects 12 through 14, further comprising: transmitting, via the control signaling, an indication of at least one of a first quantization level associated with the upper bound or a second quantization level associated with the lower bound, wherein the channel state information report indicates at least one of the upper bound confidence value based at least in part on the first quantization level or the lower bound confidence value based at least in part on the first quantization level and the second quantization level.

Aspect 16: The method of aspect 15, further comprising: receiving capability information indicating at least one of the first quantization level or the second quantization level, wherein transmitting the indication of at least one of the first quantization level or the second quantization level is based at least in part on the capability information.

Aspect 17: The method of any of aspects 15 through 16, wherein the first quantization level corresponds to a first quantity of bits and the second quantization level corresponds to a second quantity of bits.

Aspect 18: The method of any of aspects 12 through 17, wherein receiving the channel state information report comprises: receiving a first channel state information report message comprising a plurality of predicted channel characteristic values comprising the first predicted channel characteristic value and a confidence value feedback request; and receiving a second channel state information report message comprising a plurality of asymmetric confidence values corresponding to the plurality of predicted channel characteristic values based at least in part on the confidence value feedback request, the plurality of asymmetric confidence values comprising the upper bound confidence value, the lower bound confidence value, or both.

Aspect 19: The method of aspect 18, further comprising: transmitting control signaling comprising an indication of a threshold confidence level, wherein receiving the first channel state information report message comprising the confidence value feedback request is based at least in part on at least one of the upper bound confidence value or the lower bound confidence value satisfying the threshold confidence level.

Aspect 20: The method of any of aspects 12 through 19, further comprising: receiving, via the channel state information report, a plurality of predicted channel characteristic values corresponding to a plurality of resources, and a set of confidence values, at least one confidence value of the set of confidence values corresponding to each predicted channel characteristic value of the plurality of predicted channel characteristic values, wherein the plurality of predicted channel characteristic values comprises the first predicted channel characteristic value, and the set of confidence values comprises the upper bound confidence value and the lower bound confidence value.

Aspect 21: The method of any of aspects 12 through 20, wherein a channel characteristic comprise a reference signal receive power, a signal to interference and noise ratio, a rank indicator, a channel quality information, or any combination thereof.

Aspect 22: The method of any of aspects 12 through 21, wherein the predicted channel characteristic value, the upper bound confidence level, the lower bound confidence level, or any combination thereof, is based at least in part on the resources in a frequency domain, a time domain, a spatial domain, or any combination thereof.

Aspect 23: An apparatus for wireless communications at a UE, comprising a processor; memory coupled with the processor; and instructions stored in the memory and executable by the processor to cause the apparatus to perform a method of any of aspects 1 through 11.

Aspect 24: An apparatus for wireless communications at a UE, comprising at least one means for performing a method of any of aspects 1 through 11.

Aspect 25: A non-transitory computer-readable medium storing code for wireless communications at a UE, the code comprising instructions executable by a processor to perform a method of any of aspects 1 through 11.

Aspect 26: An apparatus for wireless communications at a network entity, comprising a processor; memory coupled with the processor; and instructions stored in the memory and executable by the processor to cause the apparatus to perform a method of any of aspects 12 through 22.

Aspect 27: An apparatus for wireless communications at a network entity, comprising at least one means for performing a method of any of aspects 12 through 22.

Aspect 28: A non-transitory computer-readable medium storing code for wireless communications at a network entity, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processors;
memory coupled with the processor; and
instructions stored in the memory and executable by the processor to cause the apparatus to:
receive control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction;
generate, according to the asymmetric confidence value reporting scheme, a first predicted channel characteristic value for the resource, and at least one of an upper bound confidence value for the first predicted channel characteristic value or a lower bound confidence value for the first predicted channel characteristic value; and
transmit a channel state information report indicating the first predicted channel characteristic value and at least one of the upper bound confidence value or the lower bound confidence value for the first predicted channel characteristic value.

2. The apparatus of claim 1, wherein the instructions to transmit the channel state information report are executable by the processor to cause the apparatus to:
transmit the channel state information report that indicates both the upper bound confidence value and the lower bound confidence value, wherein the lower bound confidence value is different than the upper bound confidence value.

3. The apparatus of claim 1, wherein the instructions are further executable by the processor to cause the apparatus to:
receive, via the control signaling, an instruction to report a single confidence value associated with the lower bound, wherein the channel state information report indicates the first predicted channel characteristic value and the lower bound confidence value.

4. The apparatus of claim 1, wherein the instructions are further executable by the processor to cause the apparatus to:
receive, via the control signaling, an indication of at least one of a first quantization level associated with the upper bound or a second quantization level associated with the lower bound, wherein the channel state information report indicates at least one of the upper bound confidence value based at least in part on the first quantization level or the lower bound confidence value based at least in part on the second quantization level.

5. The apparatus of claim 4, wherein the instructions are further executable by the processor to cause the apparatus to:
transmit capability information indicating at least one of the first quantization level or the second quantization level, wherein receiving the indication of at least one of the first quantization level or the second quantization level is based at least in part on the capability information.

6. The apparatus of claim 4, wherein:
the first quantization level corresponds to a first quantity of bits and the second quantization level corresponds to a second quantity of bits.

7. The apparatus of claim 1, wherein the instructions to transmit the channel state information report are executable by the processor to cause the apparatus to:
transmit a first channel state information report message comprising a plurality of predicted channel characteristic values comprising the first predicted channel characteristic value and a confidence value feedback request; and
transmit a second channel state information report message comprising a plurality of asymmetric confidence values corresponding to the plurality of predicted channel characteristic values based at least in part on the confidence value feedback request, the plurality of asymmetric confidence values comprising the upper bound confidence value, the lower bound confidence value, or both.

8. The apparatus of claim 7, wherein the instructions are further executable by the processor to cause the apparatus to:
receive control signaling comprising an indication of a threshold confidence level, wherein transmitting the first channel state information report message comprising the confidence value feedback request is based at least in part on at least one of the upper bound confidence value or the lower bound confidence value satisfying the threshold confidence level.

9. The apparatus of claim 1, wherein the instructions are further executable by the processor to cause the apparatus to:
transmit, via the channel state information report, a plurality of predicted channel characteristic values corresponding to a plurality of resources comprising the resource, and a set of confidence values, at least one confidence value of the set of confidence values corresponding to at least one predicted channel characteristic value of the plurality of predicted channel characteristic values, wherein the plurality of predicted channel characteristic values comprises the first predicted channel characteristic value, and the set of confidence values comprises the upper bound confidence value and the lower bound confidence value.

10. The apparatus of claim 1, wherein a channel characteristic comprises a reference signal receive power, a signal to interference and noise ratio, a rank indicator, a channel quality information, or any combination thereof.

11. The apparatus of claim 1, wherein the predicted channel characteristic value, the upper bound confidence value, the lower bound confidence value, or any combination thereof, is based at least in part on the resources in a frequency domain, a time domain, a spatial domain, or any combination thereof.

12. An apparatus for wireless communications at a network entity, comprising:
a processor;
memory coupled with the processor; and
instructions stored in the memory and executable by the processor to cause the apparatus to:
transmit control signaling indicating an asymmetric confidence value reporting scheme for channel characteristic prediction for a resource, the asymmetric confidence value reporting scheme indicating an upper bound for the channel characteristic prediction that is asymmetric to a lower bound for the channel characteristic prediction;
transmit one or more reference signals via the resource; and
receive a channel state information report indicating a first predicted channel characteristic value and at least one of an upper bound confidence value or a lower bound confidence value for the first predicted channel characteristic value.

13. The apparatus of claim 12, wherein the instructions to receive the channel state information report are executable by the processor to cause the apparatus to:
receive the channel state information report that indicates both the upper bound confidence value and the lower bound confidence value, wherein the lower bound confidence value is different than the upper bound confidence value.

14. The apparatus of claim 12, wherein the instructions are further executable by the processor to cause the apparatus to:
transmit, via the control signaling, an instruction to report a single confidence value associated with the lower bound, wherein the channel state information report indicates the first predicted channel characteristic value and the lower bound confidence value.

15. The apparatus of claim 12, wherein the instructions are further executable by the processor to cause the apparatus to:
transmit, via the control signaling, an indication of at least one of a first quantization level associated with the upper bound or a second quantization level associated with the lower bound, wherein the channel state information report indicates at least one of the upper bound confidence value based at least in part on the first quantization level or the lower bound confidence value based at least in part on the first quantization level and the second quantization level.

16. The apparatus of claim 15, wherein the instructions are further executable by the processor to cause the apparatus to:
receive capability information indicating at least one of the first quantization level or the second quantization level, wherein transmitting the indication of at least one of the first quantization level or the second quantization level is based at least in part on the capability information.

17. (canceled)

18. The apparatus of claim 12, wherein the instructions to receive the channel state information report are executable by the processor to cause the apparatus to:
receive a first channel state information report message comprising a plurality of predicted channel characteristic values comprising the first predicted channel characteristic value and a confidence value feedback request; and
receive a second channel state information report message comprising a plurality of asymmetric confidence values corresponding to the plurality of predicted channel characteristic values based at least in part on the confidence value feedback request, the plurality of asymmetric confidence values comprising the upper bound confidence value, the lower bound confidence value, or both.

19. The apparatus of claim 18, wherein the instructions are further executable by the processor to cause the apparatus to:
transmit control signaling comprising an indication of a threshold confidence level, wherein receiving the first channel state information report message comprising the confidence value feedback request is based at least in part on at least one of the upper bound confidence value or the lower bound confidence value satisfying the threshold confidence level.

20. The apparatus of claim 12, wherein the instructions are further executable by the processor to cause the apparatus to:
receive, via the channel state information report, a plurality of predicted channel characteristic values corresponding to a plurality of resources, and a set of confidence values, at least one confidence value of the set of confidence values corresponding to each predicted channel characteristic value of the plurality of predicted channel characteristic values, wherein the plurality of predicted channel characteristic values comprises the first predicted channel characteristic value, and the set of confidence values comprises the upper bound confidence value and the lower bound confidence value.

21.-22. (canceled)

23. A method for wireless communications at a user equipment (UE), comprising:
receiving control signaling indicating an asymmetric confidence value reporting scheme for channel characteristics prediction for a resource, the asymmetric confidence value reporting scheme indicating an upper bound for the channel characteristic prediction that is asymmetric to a lower bound for the channel characteristic prediction;
generating, according to the asymmetric confidence value reporting scheme, a first predicted channel characteristic value for the resource, and at least one of an upper bound confidence value for the first predicted channel characteristic value or a lower bound confidence value for the first predicted channel characteristic value; and
transmitting a channel state information report indicating the first predicted channel characteristic value and at least one of the upper bound confidence value or the lower bound confidence value for the first predicted channel characteristic value.

24.-30. (canceled)
